(19) United States
(12) Patent Application Publication
(10) Pub. No.: US 2009/0030777 A1
(43) Pub. Date: Jan. 29, 2009

(54) System and Method for Message-Based Bookmarking

(76) Inventors: Thomas L. Bridges, Melbourne Beach, FL (US); Mathew S. Solar, Indialantic, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/178,438

(22) Filed: Jul. 23, 2008

Related U.S. Application Data
(60) Provisional application No. 60/961,653, filed on Jul. 23, 2007.

(51) Int. Cl. G06Q 30/00

(52) U.S. Cl. 705/10; 705/14

(57) ABSTRACT

A method and system for collecting information on advertisers, products, and/or services of interest to a consumer. The present invention provides a bridge between the physical world and the virtual world that is beneficial to both consumers and advertisers. When a consumer participating in a consumer loyalty system is exposed to an advertisement of interest containing an alphanumeric identifier of the present invention, the consumer may send an initiation message to the alphanumeric identifier and thereafter the consumer's profile within the consumer loyalty system is mapped or linked to the profile of the participating advertiser. Such alphanumeric identifiers may be incorporated into all forms of known advertising media. The present invention provides a method and system for a consumer to easily bookmark a specific advertiser, product, and/or service for later review without having to write down or memorize a URL address or any other contact information.

### CROSS REFERENCE TO RELATED APPLICATIONS

This application claims the benefit of provisional patent application Ser. No. 60/961,653, filed with the USPTO on Jul. 23, 2007, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to an information delivery system between consumer and advertisers, more specifically, the present invention relates to information delivery and interactive messaging capabilities for use by consumers and advertisers.

2. Background Art

The Internet is a worldwide interconnection of computer networks that has become a global electronic marketplace of goods and services as well as of ideas and information. Millions of computers, from low end personal computers to high end super computers, are connected to the Internet. The transformation of the Internet into a global marketplace was driven in large part by the introduction of an information system known as the World Wide Web (“the web”). In essence, the web is a distributed database that provides wide access to a large universe of database records in the form of documents known as “pages”. These pages reside on web servers and are accessible via the Internet. The web is therefore a vast database of information dispersed across an enormous number of individual computer systems. Computers connected to the Internet may access web pages via a program known as a browser, which has a powerful, simple-to-learn graphical user interface. One technique supported by the web browser is known as hyperlinking, which permits web page authors to create links to other web pages which users can then retrieve by using simple point-and-click commands on the web browser.

Web pages may be constructed in any one of a variety of formatting conventions, such as Hyper Text Markup Language (HTML), and may include multimedia information content such as graphics, audio, and moving pictures. Any individual with a computer and a connection to the Internet may access any publicly accessible page posted on the web. Thus, a presence on the World Wide Web has the capability to introduce a worldwide base of consumers to advertisers, businesses, individuals, and institutions seeking to advertise their products and services to potential customers. Furthermore, the ever increasing sophistication in the design of web pages, made possible by increasing data transmission rates and computer processing speeds, makes the web an increasingly attractive medium for advertising and other business purposes, as well as for the free flow of information.

In addition to the Internet, the recent proliferation of mobile phones has created a new lifestyle for consumers. Consumers have grown accustomed to using mobile phones anywhere they go. In many cases, users can receive emails on their mobile phones, and this brings more flexibility and mobility to their lives. In accordance with this trend, many companies have attempted to make mobile phones Internet-enabled to allow their customers to access the Internet to get the information they need anytime, anywhere. However, using a mobile phone as a replacement for a personal computer, for example, to do any kind of comprehensive Internet searching can be extremely cumbersome and thus has not been well adopted by consumers. There is a vast amount of information that consumers could use while away from their homes or offices, but unfortunately the inherent limitations of using a mobile phone as an Internet access point presents a challenge to consumers who want to access that body of information.

Additionally, accessing the Internet from a user's mobile phone requires a special phone that is capable of accessing the Internet as well as a data service plan offered by the user's mobile phone company. These mobile phones that are capable of accessing the Internet are usually more expensive than traditional mobile phones and are often difficult to operate, especially by non-tech savvy users. Furthermore, the data service plans offered by mobile phone companies can be expensive, thereby eliminating potential users who do not wish to pay an extra monthly fee for Internet access. Many potential solutions have been offered for creating ease of use in accessing information from the Internet using a mobile phone; however, all of these previous solutions still have the drawback of requiring costly and complicated Internet-accessible phones and sometimes expensive data service plans.

When a consumer is looking for or happens upon a specific product, service, or advertiser of interest, he often finds himself in a situation where he does not have a good way of remembering or recording information relating to the discovered product, service, or advertiser, such as merchant name, pricing, or a means for obtaining more detailed information about the product, service, or advertiser itself. For example, a buyer may routinely be exposed to a multitude of advertisements in passing during their regular daily regime. There is most likely no detailed information immediately available regarding the product or advertiser, and it may be necessary for the interested party to review the advertisement content again (which may or may not happen) once additional information is obtained. It is also difficult for the buyer to make an immediate comparison among potential products or services of interest. To save time and effort, it is beneficial for the buyer to have an easy, quick and inexpensive (or free) way to retrieve information about a product, service, or advertiser and to be able to store such information electronically for later retrieval, review, and/or comparison purposes. Since advertisements bombard consumers constantly throughout their day, the most appropriate means to bookmark a product, service, or specific advertiser is one that is mobile and battery powered, such as a PDA or cell phone. Short Message Service (hereinafter “SMS”), a service from wireless communication service providers, provides enabling technology for implementing a new system for distributing information on products, services, and/or advertisers. SMS allows consumers to send text messages from their mobile devices to a shortened four or five-digit telephone number (“shortcode”) following instructions found in signs, printed advertisements, and other marketing materials and to possibly receive back one or more communications via a consumer/merchant social network for accessing web-based information, the content of which corresponds to the keywords or code depicted in the advertisement. A networked computer system or consumer loyalty system may store information relating to the products and services of participating advertisers within its profile database. Such a system may be able to receive a shortcode from a mobile device through wireless service providers and then to transmit information relating to a particular product, service, or advertiser back to the consumer via their unique consumer profile within the consumer loyalty system.

Existing consumer/merchant social network systems on the market do not hybridize SMS with other data technologies to map or link product or service information of an advertiser to a consumer's profile in a consumer loyalty system. For example, some industrial magazines put “code numbers” on the advertisements in their magazines and include a pre-addressed post card in the back that has all of the codes listed. The subscriber can then simply circle the code numbers of the advertisements they want more information on, add any contact info they choose such as email address, phone number or mailing address, and drop it in the mail. When the card is received, a connection can then be made between the subscriber and the advertiser. This process however can take several weeks. Aside from such an example, the current state of the art does not provide an adequate means of allowing an exchange of information between a consumer and an advertiser and/or other business retailer.

The above mentioned conventional systems and methods have many problems and disadvantages. Existing products have yet to combine the use of SMS messages with current advertising delivery methods, such as display ads, billboards, publication ads, television ads, internet ads, and the like. Existing products do not employ a unique, easy to remember, alphanumeric sequence expressed in an advertisement which, when sent to a specific shortcode in an SMS message from a consumer's mobile device, allows an electronic messaging system to correctly extract predefined information about a product, service, or advertiser from an advertisement and send and/or bookmark such predefined information to the consumer's unique profile within a consumer loyalty system.

Therefore, a number of unaddressed needs exist in the industry and the present invention remedies the aforementioned deficiencies and inadequacies.

Frequently, a consumer may be exposed to an advertisement for a product, service, or advertiser, etc. that he or she may not be familiar with. This may be in a magazine, at the retailer's physical location via signage, on a park bench, in a radio advertisement, on a billboard, taxi cab, or even on the side of a bus. The consumer wants to make a mental note to find out more about the product, service or advertiser, look them up on the web, visit the location or make a return visit at a later point, but the consumer may not want to write down or try to remember the web address, street address or the other information that may be required to find the advertiser/retailer again.

Businesses (e.g. advertisers) need to facilitate such ways to build their customer base. Likewise, consumers need an efficient system and method to collect information on businesses with whom they choose to do business. SMS bookmarking of the present invention provides a bridge between the virtual and physical worlds that results in a win-win for both businesses and consumers. Within systems and methods of the present invention, consumers may now see businesses in the real world which they may choose to bookmark in the virtual world, and such participating businesses may gain the benefit or additional customers and thereby increase sales.

### BRIEF SUMMARY OF THE INVENTION

In accordance with one embodiment of the present invention, a method for message-based bookmarking between at least one consumer and at least one advertiser, the method comprising the steps of receiving an initiation message from a communication device of the at least one consumer, wherein the initiation message is sent by the at least one consumer to a unique alphanumeric identifier incorporated into an advertisement of the at least one advertiser, retrieving information corresponding to the at least one consumer and the at least one advertiser, and mapping an advertiser profile of the at least one advertiser to a consumer profile of the at least one consumer, wherein the advertiser profile and the consumer profile are elements within a consumer loyalty system and the mapping step provides the at least one consumer access to the advertiser profile within the consumer loyalty system.

In accordance with another embodiment of the present invention, a system for message-based bookmarking between at least one consumer and at least one advertiser, the system comprising a means for receiving an initiation message from a communication device of the at least one consumer, wherein the initiation message is sent by the at least one consumer to a unique alphanumeric identifier incorporated into an advertisement of the at least one advertiser, a means for retrieving information corresponding to the at least one consumer and the at least one advertiser, and a means for mapping an advertiser profile of the at least one advertiser to a consumer profile of the at least one consumer, wherein the advertiser profile and the consumer profile are elements within a consumer loyalty system and the mapping step provides the at least one consumer access to the advertiser profile within the consumer loyalty system.

In accordance with another embodiment of the present invention, a system for message-based bookmarking between at least one consumer and at least one advertiser wherein the at least one consumer is exposed to an advertisement of interest containing a unique alphanumeric identifier, the system comprising a networked computer system comprising a profile database containing a consumer profile and an advertiser profile, wherein each of the advertiser profiles are identifiable and retrievable via the unique alphanumeric identifier contained in the advertisement and the consumer profile is mapped to the advertiser profile, wherein, in operation, after exposure to the advertisement of interest incorporating the unique alphanumeric identifier the at least one consumer sends an initiation message to the unique alphanumeric identifier, the networked computer system receives the initiation message from a communication device of the at least one consumer, and in response, the networked computer system retrieves information corresponding to the at least one consumer and the at least one advertiser, and the networked computer system maps the advertiser profile of the at least one advertiser to the consumer profile of the at least one consumer, wherein the advertiser profile and the consumer profile are elements within a consumer loyalty system on the networked computer system and the mapping provides the at least one consumer access to the advertiser profile within the consumer loyalty system.

### BRIEF DESCRIPTION OF THE DRAWINGS

FIG. 1 depicts a simplified block diagram of an embodiment of a system of the present invention.

FIG. 2 depicts a simplified block diagram of an embodiment of a system of the present invention.

FIG. 3 depicts a simplified flow diagram of method steps followed in an embodiment of the present invention.

FIG. 4 depicts a simplified flow diagram of method steps followed in an embodiment of the present invention.

FIG. 5 depicts a simplified flow diagram of method steps followed in an embodiment of the present invention.

FIG. 6 depicts a simplified flow diagram of method steps followed in an embodiment of the present invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The present invention provides an “exchange” of information between consumers and advertisers that are members of any consumer loyalty systems or consumer networks known within the art, such as those disclosed in U.S. patent application Ser. Nos. 11/454,270 filed on Jun. 16, 2006; 11/606,530 filed on Nov. 30, 2006; 11/653,169 filed on Jan. 12, 2007; and 60/872,196 filed on Dec. 1, 2006; which are herein incorporated by reference in their entirety. This means that not only may an advertiser obtain information on the consumer, but the consumer may obtain information on the advertiser, product, or service (whether they make a purchase or not) by simply swiping a consumer loyalty system card at the retailer establishment as disclosed in the above patent applications. This vision has been extended by applicant's prior applications to include the concept of a “Virtual Visit” where a consumer can obtain information on a participating business retailer by linking or adding them to the consumer's unique consumer profile page located within the consumer loyalty system.

A need exists in the marketplace to further allow this exchange of information so that a consumer may bookmark a specific business advertiser/business of interest when it is not possible to swipe their card or make a virtual visit.

When a potential consumer is surfing the internet and they come across a business or a website that they want to return to, they “Bookmark” it and it is stored under “My Favorites” in their web browser. The solution of the present invention disclosed here is somewhat analogous to that method but rather than using the internet directly, the consumers make the initial connection using a communication device, such as a cell phone, and may thereafter review more detailed information online from their unique consumer profile in the consumer loyalty system.

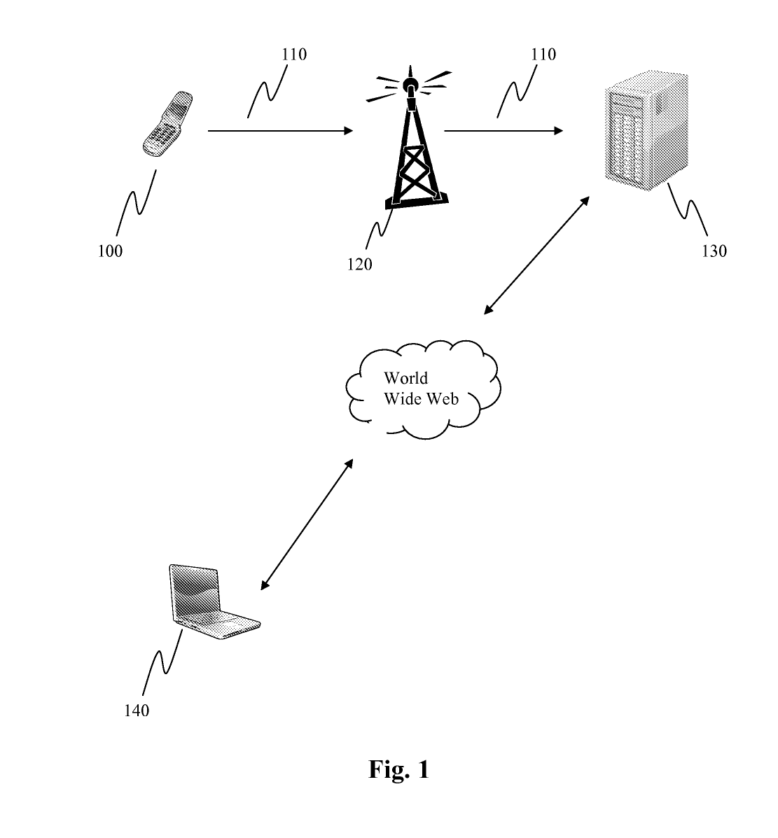

From FIG. 1 the reader will see that, according to one embodiment of the invention, the present invention allows a consumer to gather information on advertisers or businesses with which they choose to do business. By utilizing the systems and methods of the present invention, a consumer is capable of linking a unique consumer profile to a plurality of advertiser profiles, business profiles, and/or retailer profiles. The present disclosure assumes the pre-existence of both consumer and such advertiser profiles with a consumer loyalty program or other consumer network utilized in conjunction with a system and method of the present invention. Such a mapping between accounts may provide a means of two-way communication between the consumer and advertisers. In such a manner, the consumer may receive business information such as store hours, locations, current promotions, and more detailed information regarding an advertising campaign, while advertisers may be able to analyze their consumer demographic characteristics or offer special incentive opportunities to consumers known to have interest in their products or services.

Many consumers already access the websites of their preferred business retailers and many advertisers may already track active consumers with consumer loyalty programs, club cards, and the like. The present invention allows such a connection to be made without requiring the consumer to go either online or visit the premises of an advertiser or retailer. Consumers may bookmark any number of advertisers of interest and have these businesses linked to their unique consumer profiles within the consumer loyalty system or other consumer network. The system of the present invention eliminates a retailer's need for specific hardware to be located at their place of business and further allows on-the-go consumers to link advertisers and businesses of interest to their unique consumer profile without requiring either an online visit to an advertiser's website or a physical visit to a business location to initiate such a link or connection. Additionally, a link or connection as disclosed in the present invention may provide for a historical record in the form of electronic or printed reports of consumer inquiries regarding a specific advertising campaign, product, or service being offered. In this manner, advertisers and businesses may track the effectiveness of their advertising campaigns by means of the volume of interest received from consumers utilizing the systems and methods of the present invention.

In use, a user may first be exposed to (e.g. see, hear, and the like) an advertisement for a product, service, or advertiser of interest. The advertisement may take many forms including, but not limited to, television ads, magazine or periodical ads, store signs, billboards, radio ads, and any other forms of advertisements known in the art. The advertisement may include and incorporate a unique alphanumeric identifier that may take many forms, wherein the preferred forms may include a keyword, numerical sequence, or any combination thereof. This unique alphanumeric identifier serves as the link to the specific advertiser's profile on the consumer loyalty system or other consumer network.

As depicted in FIG. 1, the consumer may then communicate 110 an initiation message via a unique alphanumeric identifier from a personal communication device 100 to a system of the present invention. Any known personal communication device 100 may be used including but not limited to a wired telephone, a wireless telephone, a PDA, a kiosk, a set-top television box, and the like. The preferred form of communication being an SMS (Simple Message Service) message from a wireless telephone having a specified telephone number associated thereto. The specified telephone number sends 110 the initiation message (e.g. a SMS message) to a server 130 of the system of the present invention and allows identification of the consumer via their personal communication device 100. A unique telephone number or other form of unique consumer profile identifier may be associated with the communication device 100 allowing identification of the consumer communicating 110 the unique alphanumeric identifier to the system of the present invention.

In the above example, the server 130 may convert the associated consumer telephone number or other unique consumer profile identifier into a virtual visit transaction for that particular consumer and then map or link the interested consumer's profile (via their person communication device information) to the desired advertiser's profile (via the unique alphanumeric identifier used by the consumer). The advertiser profile associated with the unique alphanumeric identifier is now mapped to the specific consumer profile and bookmarked in the consumer's account within the consumer loyalty system or other consumer network. In this manner via the system and method of the present invention, the consumer may thereafter reference the bookmarked advertiser profile via the consumer's profile. The consumer may access their consumer profile within the consumer loyalty system or other consumer network through any Internet enabled device.

Such bookmarking and consumer access allow consumers to find a wide variety of advertiser information including, but not limited to, store locations, business hours, current promotions, current advertising campaigns, and the like. Additionally, the advertisers may be enabled to communicate business news, incentives and/or promotions directly to consumers known to have interest in the specific advertiser, product, or service offered. The bookmarking system and method of the present invention allows the above-mentioned initiation of a two-way communication link between an advertiser of interest and each respective consumer without requiring either consumer visitation to a retail location or consumer online access of a retailer website. In this manner, conventional advertisements incorporating a unique alphanumeric identifier may be used in conjunction with consumer communication devices to automatically provide a link or map between advertisers and consumer under the system and method of the present invention.

Each advertiser or business that participates in the system and method of the present invention may be provided a code or unique alphanumeric identifier that could be associated with and/or displayed on all of their advertisements; be it print, store front, billboard, radio promotions, television commercials, and the like. When the consumer sees an advertisement for something they want to remember or return to at a later time, the consumer may simply send an initiation message, such as a SMS message, to the advertiser's unique alphanumeric identifier contained within the advertisement. In this manner, a “virtual visit” may be logged for the consumer with that specific advertiser or business retailer on the consumer loyalty system or other consumer network being used in conjunction with the present invention. The next time the consumer logs into their consumer profile, the consumer profile may provide a link to the advertiser's profile and the consumer may also have an incentive waiting for them from that specific advertiser.

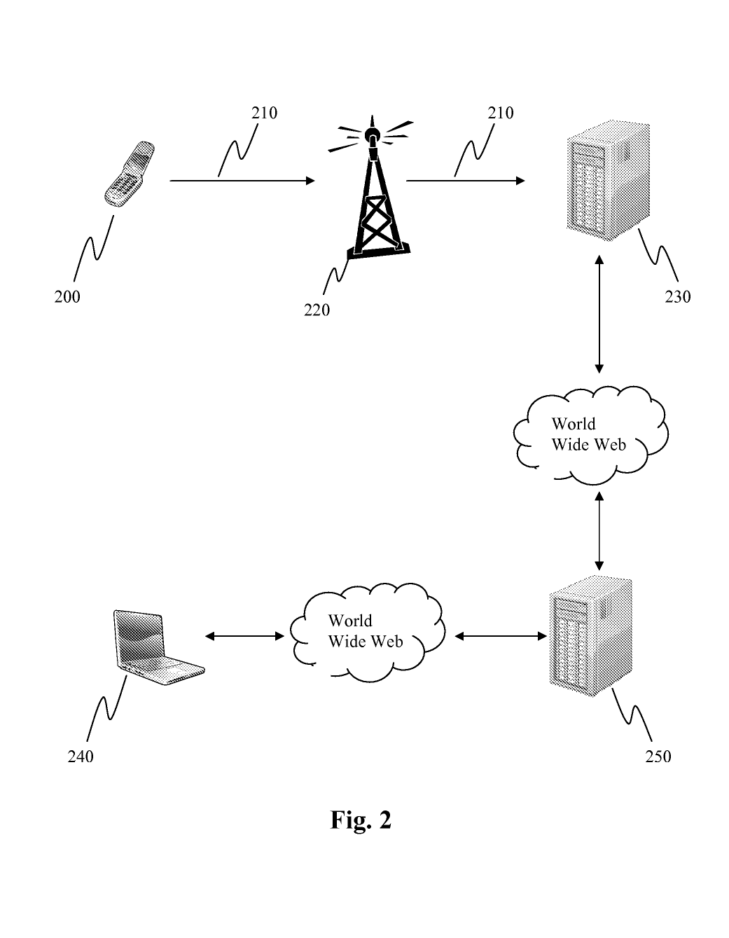

As depicted in FIG. 1, a consumer that is exposed to an advertisement containing a unique alphanumeric identifier may send 110 an initiation message via a communication device 100 to a server 130 of the present invention. The initiation message may be sent via any known network 120, such as any wired or wireless networks known within the art. Both FIGS. 1 and 2 depict an antenna representative of a wireless telecommunication network 120 as a preferred embodiment within the scope of the present invention. The communication device 100 may include but is not limited to a wired telephone, a wireless telephone, a PDA, a kiosk, a set-top television box, and the like. The initiation message is sent to the unique alphanumeric identifier that was incorporated into the advertisement. The server 130 of FIG. 1 may receive the initiation message and, from the incoming unique alphanumeric identifier, the server 130 may determine which advertisement and advertiser the consumer desires to bookmark. Advertisers may previously have registered for an advertiser profile within the consumer loyalty system or other consumer network, and the unique alphanumeric identifier used in the advertisements of the advertiser may be associated with the respective advertiser's profile. Knowing which advertiser the consumer wishes to bookmark, the server 130 may generate a link or map from the consumer's profile to the advertiser's profile via an HTML link or any other network linking means known within the art. The consumer may then access the newly bookmarked link at any time thereafter to review information regarding the advertisement and/or advertiser via accessing their consumer profile online within the consumer loyalty system or other consumer network. The consumer may utilize any web-enabled device 140 to access their consumer profile online, wherein such a web-enabled device may include but is not limited to a desktop computer, laptop computer, PDA, web-enabled telephone, kiosk terminal, set-top television box, and the like.

FIG. 2 depicts an alternate variation within the scope of the present invention wherein a consumer exposed to an advertisement incorporating a unique alphanumeric identifier sends 210 an initiation message via a communication device 200 over a network 220 to a server 230 of a consumer loyalty system or other consumer network. The initiation message sent 210 by the consumer is addressed to the unique alphanumeric identifier that was incorporated into the advertisement. The server 230 may receive the initiation message and log the initiation message as a virtual visit transaction in the consumer loyalty system or other consumer network for the specific consumer in relation to the advertiser associated with the unique alphanumeric identifier. The consumer may be identified by the unique consumer profile identifier communicated by the initiation message, while the advertiser may be identified by the unique alphanumeric identifier to which the initiation message was sent 210. The unique consumer profile identifier may include but is not limited to the telephone number associated with the communication device 200, a unique consumer profile number input by the consumer within the initiation message, a unique consumer account number (e.g. cable television user account number) that may be associated with the consumer's profile within the consumer loyalty system or other consumer network, and the like. Depending on the architecture of the present inventive system and/or consumer loyalty system, the initiation message may then be sent to a profile database 250 of a networked computer system of the present invention wherein the consumer profile of the identified consumer may be linked or mapped to the advertiser profile of the identified advertiser. The consumer may thereafter access the link to the specific advertiser profile by logging into their consumer account via any web-enabled device 240.

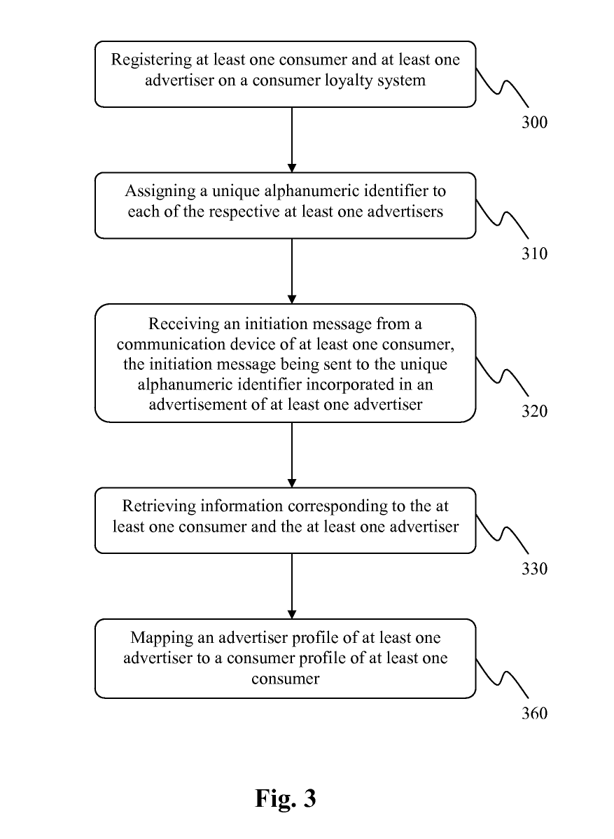

FIG. 3 depicts a simplified high-level flow diagram of an embodiment of the present invention. Initially, at least one consumer and at least one advertiser may register 300 on a consumer loyalty system or other consumer network. Upon registration, participating advertisers may then be assigned 310 a unique alphanumeric identifier which they may thereafter incorporate into their respective advertisements. In one embodiment, each participating advertiser may only be registered or associated with one unique alphanumeric identifier, wherein distinct advertising campaigns may be not be distinguishable at the point of the incoming initiation message sent from the consumer. In another embodiment, each participating advertiser may be registered or associated with a plurality of unique alphanumeric identifiers, thereby allowing respective advertising campaigns or a multitude of products or services to be distinguishable at the point of the incoming initiation message sent from the consumer. In such an embodiment, advertisers may more easily interpret feedback as to products, services, and advertising campaigns that garner the greatest amount of consumer interest. Next, the system and/or server of the present invention may receive 320 an initiation message from a communication device of at least one registered consumer, wherein the initiation message was sent to the unique alphanumeric identifier that was incorporated into an advertisement of at least registered advertiser. The system and/or server may then retrieve 330 information corresponding to the at least one consumer and the at least one advertiser. The system and/or server may then map or link 360 the advertiser profile of the registered advertiser to the consumer profile of the registered consumer.

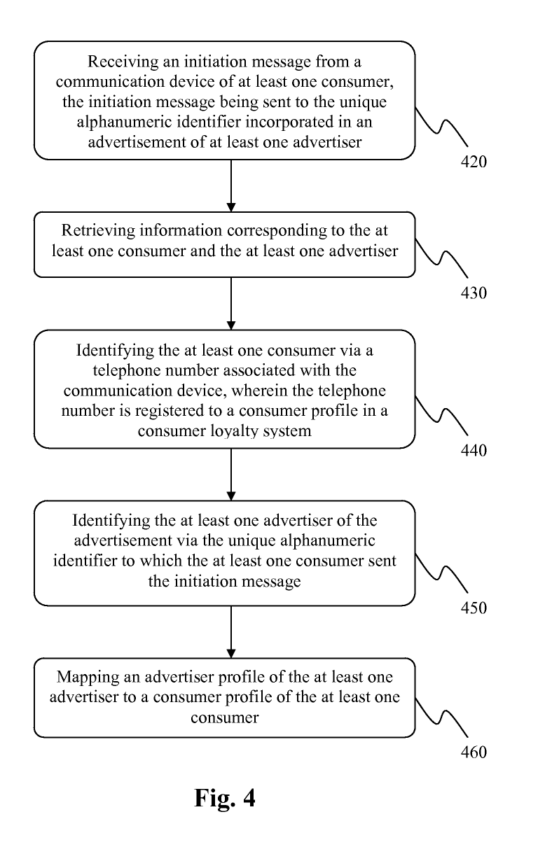

FIG. 4 depicts a simplified flow diagram of an embodiment of the present invention. The flow diagram of FIG. 4 may represent an alternate variation from the disclosure regarding the flow diagram of FIG. 3. A server of a system of the present invention may receive 420 an initiation message from a communication device of at least one registered consumer, wherein the initiation message was sent to the unique alphanumeric identifier that was incorporated into an advertisement of at least one registered advertiser. The system and/or server may then retrieve 430 information corresponding to the at least one consumer and the at least one advertiser. Such a retrieval step 430 may further comprise identifying 440 the at least one consumer via a telephone number associated with the communication device, wherein the telephone number is registered to a consumer profile in a consumer loyalty system. The retrieval step 430 may further comprise identifying 450 the at least one advertiser of the advertisement via the unique alphanumeric identifier to which the at least one consumer sent the initiation message. The system and/or server may then map or link 460 the advertiser profile of the registered advertiser to the consumer profile of the registered consumer.

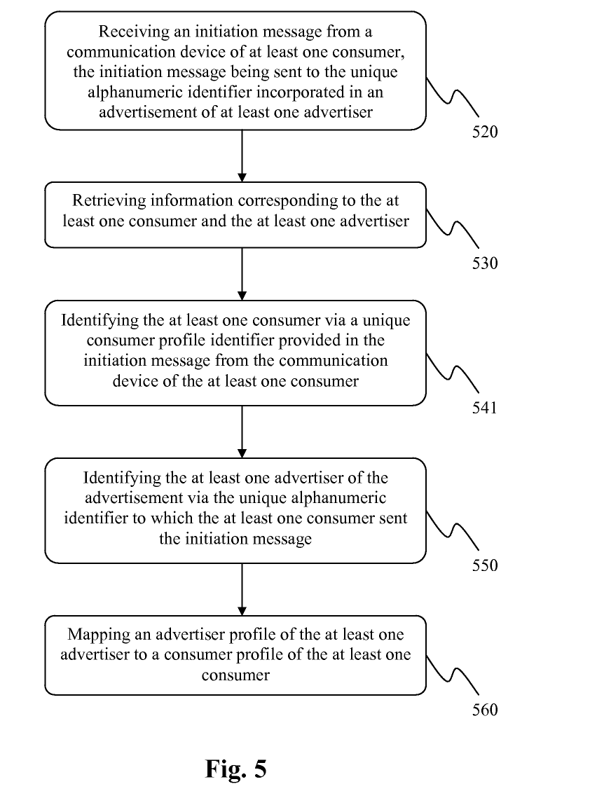

FIG. 5 depicts a simplified flow diagram of an embodiment of the present invention. The flow diagram of FIG. 5 may represent an alternate variation from the disclosure regarding the flow diagrams of FIGS. 3-4. A server of a system of the present invention may receive 520 an initiation message from a communication device of at least one registered consumer, wherein the initiation message was sent to the unique alphanumeric identifier that was incorporated into an advertisement of at least one registered advertiser. The system and/or server may then retrieve 530 information corresponding to the at least one consumer and the at least one advertiser. Such a retrieval step 530 may further comprise identifying 541 the at least one consumer via a unique consumer profile identifier provided in the initiation message from the communication device of the at least one consumer. The unique consumer profile identifier may include but is not limited to the telephone number associated with the communication device, a unique consumer profile number input by the consumer within the initiation message, a unique consumer account number (e.g. cable television user account number) that may be associated with the consumer's profile within the consumer loyalty system or other consumer network, and the like. The retrieval step 530 may further comprise identifying 550 the at least one advertiser of the advertisement via the unique alphanumeric identifier to which the at least one consumer sent the initiation message. The system and/or server may then map or link 560 the advertiser profile of the registered advertiser to the consumer profile of the registered consumer.

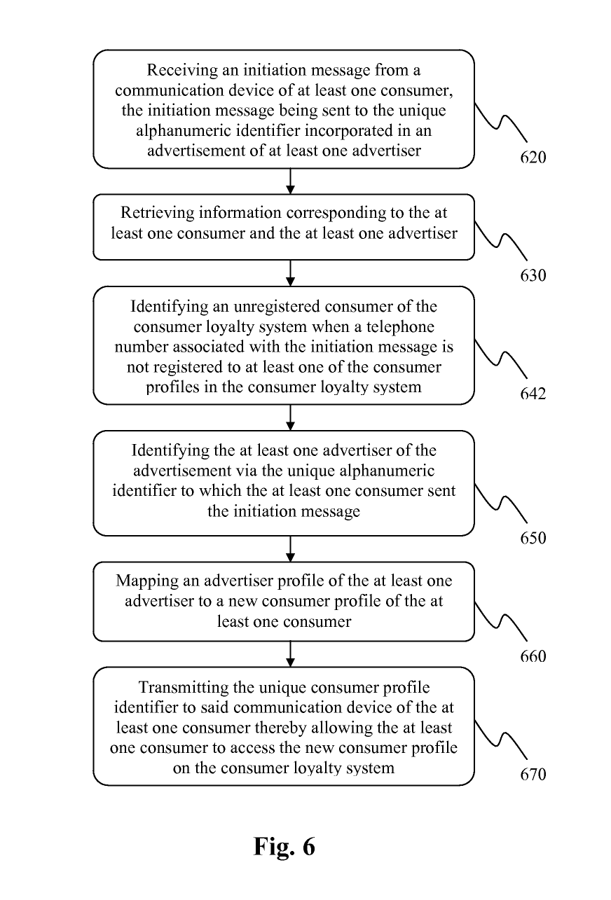

FIG. 6 depicts a simplified flow diagram of an embodiment of the present invention. The flow diagram of FIG. 6 may represent an alternate variation from the disclosure regarding the flow diagrams of FIGS. 3-5. A server of a system of the present invention may receive 620 an initiation message from a communication device of at least one registered consumer, wherein the initiation message was sent to the unique alphanumeric identifier that was incorporated into an advertisement of at least one registered advertiser. The system and/or server may then retrieve 630 information corresponding to the at least one consumer and the at least one advertiser. Such a retrieval step 630 may further comprise identifying 642 an unregistered consumer of the consumer loyalty system when a telephone number associated with the initiation message is not registered to at least one of the consumer profiles within the consumer loyalty system. The retrieval step 630 may further comprise identifying 650 the at least one advertiser of the advertisement via the unique alphanumeric identifier to which the at least one consumer sent the initiation message. The system and/or server may then map or link 660 the advertiser profile of the registered advertiser to the consumer profile of the registered consumer. Finally, the system and/or server may transmit 670 the unique consumer profile identifier to the communication device of the at least one consumer thereby allowing the at least one consumer to access their newly created consumer profile within the consumer loyalty system.

As disclosed above and in FIGS. 3-6, the scope of the present invention includes embodiments for a wide range of scenarios regarding bookmarking an advertiser for a consumer. In one instance, when a consumer is using a wireless phone that is registered with a consumer loyalty system, the consumer only needs to send an initiation message (e.g. a SMS message) to the unique alphanumeric identifier that was incorporated into the advertisement of interest, wherein profiles to be linked or mapped may be ascertained from the wireless phone number and the unique alphanumeric identifier used. In a second instance, when a consumer is using a wireless phone that is not registered with the consumer loyalty system, the consumer only needs to send an initiation message to the unique alphanumeric identifier that was incorporated into the advertisement of interest, wherein the consumer may input their unique consumer profile identifier into the initiation message to allow for profile linking or mapping to occur. In a third instance, the consumer may place a call to a telephone number associated with the system from a land line or wireless phone, wherein the consumer may follow voice prompts to enter the unique alphanumeric identifier as well as their unique consumer profile identifier via voice recognition, keystrokes, and the like. In a fourth instance, if the consumer is not registered with the consumer loyalty system, a new consumer profile may be created and the unique consumer profile identifier transmitted to the consumer's communication device to allow access to the newly created consumer profile having a new advertiser link within the consumer loyalty system.

Generally, a server may recognize a consumer's communication device that has been associated with or tied to their unique consumer profile within the consumer loyalty system. Consumers who do not yet have a consumer profile within the consumer loyalty system may get a return message with an incentive to go online and register with the consumer loyalty system. Advertisers may offer any customizable incentive such as discounts, sale pricing, free promotions, exclusive offers, and the like, to entice consumers to register and thereby be able to share information with advertisers having products or services of interest to the consumer.

The present invention is preferably adapted to web-enabled wireless telephones. A very lightweight HTML interface may allow the consumer to enter the advertiser's unique alphanumeric identifier directly onto the web server of the consumer loyalty system to provide the map or link to the advertiser profile. This invention is also adaptable to a wide variety of other networks, including but not limited to kiosks or set-top television boxes that offer the ability to look through a directory of advertisers and/or businesses, and may further allow for virtual visits within the consumer loyalty system. Such embodiments may be particularly useful in the hotel industry where a listing containing local stores and restaurants is normally provided. In use, the initiation message may include but is not limited to a user input selection made via a set-top television box while viewing a television or other viewing device, a user touch screen or stylus input at a kiosk terminal (e.g. electronic directory at a shopping mall or an electronic local entertainment directory at a hotel), and the like. In one such embodiment, a consumer may link their consumer profile within the consumer loyalty system to their television service network (e.g. cable, satellite, and the like), wherein user input (e.g. via remote control) of an initiation message after seeing an advertisement of interest provides and online link or map to the advertiser's profile within the consumer loyalty system. Likewise, a consumer may link their consumer profile within the consumer loyalty system to a local merchant or entertainment provider that is listed in an electronic shopping mall directory or an electronic entertainment directory at a hotel (e.g. electronic concierge), and the like. After selecting a retailer or entertainment provider, the consumer may be asked to input a unique consumer profile identifier to allow for the mapping or linking of the consumer profile to the advertiser profile within the consumer loyalty system.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A method for message-based bookmarking between at least one consumer and at least one advertiser, said method comprising the steps of:
receiving an initiation message from a communication device of said at least one consumer, wherein said initiation message is sent by said at least one consumer to a unique alphanumeric identifier incorporated into an advertisement of said at least one advertiser;
retrieving information corresponding to said at least one consumer and said at least one advertiser; and
mapping an advertiser profile of said at least one advertiser to a consumer profile of said at least one consumer, wherein said advertiser profile and said consumer profile are elements within a consumer loyalty system and said mapping step provides said at least one consumer access to said advertiser profile within said consumer loyalty system.

2. The method of claim 1, wherein said retrieving step further comprises the steps of:
identifying said at least one consumer via a telephone number associated with said communication device, wherein said telephone number is registered to said consumer profile in said consumer loyalty system; and
identifying said at least one advertiser of said advertisement via said unique alphanumeric identifier to which said at least one consumer sent said initiation message.

3. The method of claim 1, wherein said retrieving step further comprises the steps of:
identifying said at least one consumer via a unique consumer profile identifier provided in said initiation message from said communication device of said at least one consumer; and
identifying said at least one advertiser of said advertisement via said unique alphanumeric identifier to which said at least one consumer sent said initiation message.

4. The method of claim 1, wherein said retrieving step further comprises the steps of:
identifying at least one unregistered consumer of said consumer loyalty system when a telephone number associated with said initiation message is not registered to at least one of said consumer profiles in said consumer loyalty system and no unique consumer profile identifier is provided in said initiation message, wherein a new consumer profile is created to allow for said mapping step;
identifying said at least one advertiser of said advertisement via said unique alphanumeric identifier to which said at least one consumer sent said initiation message; and
transmitting a new unique consumer profile identifier to said communication device of said at least one consumer thereby allowing said at least one consumer to access said new consumer profile on said consumer loyalty system.

5. The method of claim 1, wherein said communication device is selected from the group consisting of a wired telephone, a wireless telephone, a PDA, a kiosk, and a set-top television box.

6. The method of claim 1, wherein said mapping step creates a first URL link in said consumer profile to facilitate said at least one consumer accessing said advertiser profile.

7. The method of claim 1, wherein said advertiser profile comprises a second URL link, wherein said second URL link provides further disclosure regarding said advertisement.

8. The method of claim 1, wherein said initiation message may be input into and delivered via a set-top television box of a television network in response to the display of said advertisement of said at least one advertiser.

9. The method of claim 1, wherein said initiation message may be input into and delivered over an electronic network via a kiosk terminal.

10. A system for message-based bookmarking between at least one consumer and at least one advertiser, said system comprising:
means for receiving an initiation message from a communication device of said at least one consumer, wherein said initiation message is sent by said at least one consumer to a unique alphanumeric identifier incorporated into an advertisement of said at least one advertiser;
means for retrieving information corresponding to said at least one consumer and said at least one advertiser; and
means for mapping an advertiser profile of said at least one advertiser to a consumer profile of said at least one consumer, wherein said advertiser profile and said consumer profile are elements within a consumer loyalty system and said mapping step provides said at least one consumer access to said advertiser profile within said consumer loyalty system.

11. The system of claim 10, wherein said means for retrieving further comprises:
means for identifying said at least one consumer via a telephone number associated with said communication device, wherein said telephone number is registered to said consumer profile in said consumer loyalty system; and
means for identifying said at least one advertiser of said advertisement via said unique alphanumeric identifier to which said at least one consumer sent said initiation message.

12. The system of claim 10, wherein said means for retrieving further comprises:
means for identifying said at least one consumer via a unique consumer profile identifier provided in said initiation message from said communication device of said at least one consumer; and
means for identifying said at least one advertiser of said advertisement via said unique alphanumeric identifier to which said at least one consumer sent said initiation message.

13. The system of claim 10, wherein said means for retrieving further comprises:
means for identifying an unregistered consumer of said consumer loyalty system when a telephone number associated with said initiation message is not registered to at least one of said consumer profiles in said consumer loyalty system and no unique consumer profile identifier is provided in said initiation message, wherein a new consumer profile is created to allow for said mapping step;
means for identifying said at least one advertiser of said advertisement via said unique alphanumeric identifier to which said at least one consumer sent said initiation message; and
means for transmitting a new unique consumer profile identifier to said communication device of said at least one consumer thereby allowing said at least one consumer to access said new consumer profile on said consumer loyalty system.

14. A system for message-based bookmarking between at least one consumer and at least one advertiser wherein said at least one consumer is exposed to an advertisement of interest containing a unique alphanumeric identifier, said system comprising:
a networked computer system comprising a server, said networked computer system storing a consumer profile and an advertiser profile wherein said advertiser profile is identifiable and retrievable via said unique alphanumeric identifier contained in said advertisement and said consumer profile is mapped to said advertiser profile;
wherein, in operation, after exposure to said advertisement of interest incorporating said unique alphanumeric identifier said at least one consumer sends an initiation message to said unique alphanumeric identifier, said networked computer system receives said initiation message from a communication device of said at least one consumer, and in response, said networked computer system retrieves information corresponding to said at least one consumer and said at least one advertiser, and said networked computer system maps said advertiser profile of said at least one advertiser to said consumer profile of said at least one consumer, wherein said advertiser profile and said consumer profile are elements within a consumer loyalty system on said networked computer system and said mapping step provides said at least one consumer access to said advertiser profile within said consumer loyalty system.

15. The system of claim 14, wherein said networked computer system retrieval of said information further comprises:
said networked computer system identifying said at least one consumer via a telephone number associated with said communication device, wherein said telephone number is registered to said consumer profile in said consumer loyalty system; and
said networked computer system identifying said at least one advertiser of said advertisement via said unique alphanumeric identifier to which said at least one consumer sent said initiation message.

16. The system of claim 14, wherein said networked computer system retrieval of said information further comprises:
said networked computer system identifying said at least one consumer via a unique consumer profile identifier provided in said initiation message from said communication device of said at least one consumer; and
said networked computer system identifying said at least one advertiser of said advertisement via said unique alphanumeric identifier to which said at least one consumer sent said initiation message.

17. The system of claim 14, wherein said networked computer system retrieval of said information further comprises:
said networked computer system identifying an unregistered consumer of said consumer loyalty system when a telephone number associated with said initiation message is not registered to at least one of said consumer profiles in said consumer loyalty system and no unique consumer profile identifier is provided in said initiation message, wherein a new consumer profile is created to allow for said mapping step;
said networked computer system identifying said at least one advertiser of said advertisement via said unique alphanumeric identifier to which said at least one consumer sent said initiation message; and
said networked computer system transmitting a new unique consumer profile identifier to said communication device of said at least one consumer thereby allowing said at least one consumer to access said new consumer profile on said consumer loyalty system.

18. The system of claim 14, wherein said networked computer system further comprises a profile database wherein said consumer profile and said advertiser profile are stored.

19. The system of claim 14, wherein said communication device is selected from the group consisting of a wired telephone, a wireless telephone, a PDA, a kiosk, and a set-top television box.

20. The system of claim 14, wherein said mapping step creates a first URL link in said consumer profile to facilitate said at least one consumer accessing said advertiser profile.
